(19) United States
(12) Patent Application Publication
(10) Pub. No.: US 2025/0128747 A1
(43) Pub. Date: Apr. 24, 2025

(54) TRANSPORT APPARATUS

(71) Applicant: Kyle Robinson, Menlo Park, CA (US)

(72) Inventors: Kyle Robinson, Menlo Park, CA (US); Michael Elwell, Kalamazoo, MI (US)

(21) Appl. No.: 18/985,381

(22) Filed: Dec. 18, 2024

(51) Int. Cl. B62B 3/10

(52) U.S. Cl. CPC B62B 3/108

(57) ABSTRACT

A transportation apparatus is provided. The apparatus includes a framework having a lower frame member and a side frame member, a flat bottom member supported on the lower frame member and has slots, and ridges, and a flat side member supported on the side frame member and includes slots and ridges. The apparatus further includes separators. The ridges of the flat bottom member and the flat side member are aligned on the same plane and include retaining spaces for slidably receiving and securing cabinet subassemblies (E.g. cabinet doors, windows, face frames). The cabinet subassemblies retained within the spaces are further separated by the separators preventing any damage to the cabinet subassemblies from rattling during the movement of the transportation apparatus.

### FIELD OF THE INVENTION

The present invention generally relates to transport apparatuses, particularly to a wheeled or a no-wheel transport apparatus configured for the transportation and storage of cabinet subassemblies such as door panels, windows, and face frames without damaging each other.

### BACKGROUND

Generally, various cabinet assemblies remain discrete units, especially cabinet doors and face frames which can be transported and handled separately. Instead of transporting assembled cabinets (which might be more space-consuming), the cabinets are transported in subassemblies consisting of rectangular frames, doors, and other components. The subassemblies are assembled into a whole system after being transported to the intended spot. However, the existing cabinets, which are assembled by subassemblies such as doors, and face frames, may easily be damaged during transport considering the stacking force and rubbing against each other.

Further, different kinds of carts, storage and transportation apparatuses, and storage cabinets are widely in use for handling cabinet doors, and face frames. However, existing solutions for storage and transportation of the doors, and face frames are restrictive in terms of their design and do not provide easy-to-use solutions, especially for doors and face frames. They are not customizable for use for doors, face panels, or even both together. Further, the existing carts, storage, transportation containers, and racks are bulky and complex in terms of their design and aren't very reliable in terms of preventing damages to adjacent cabinet doors, and face frames mounted thereon for transportation.

Several attempts have been made to provide storage and transport solutions for cabinet doors and/or face frames. One such attempt is disclosed in US20080157640 which discloses a cabinet facilitating storage, transport, and assembly, and its packing method. Different sorts of pallet racks with M-Dividers are in use, especially for storage of doors, and face frames in warehouses, for example, one being sold by Warehouse Rack & Shelf LLC. Some other standard portable, stackable window and door racks retrofitted with pallet rack casters are designed to safely and efficiently transport windows, doors, and face frames around the workshop, warehouse, or construction sites, for example, the one being sold by Warehouse Rack & Shelf LLC. However, such racks do not protect the windows, doors, and face frames from damage due to rattling while the racks carrying them are in motion. Additionally, Sunbelt Rack™ produces millwork stack racks that are movable, stackable storage systems for windows, doors, and other products. Although movable and can be used to transport the windows, doors, face frames, etc., they do not either protect the windows, doors, face frames, etc from damage or even if they offer separation between the windows, doors, and face frames, the separation is not reliable. Further, most of these available solutions are designed with the motive of saving warehouse space.

Though various types of carts, storage, and transportation apparatuses are already available in the market for the intended purpose, the objective of the present invention is to provide a more simplistic, modular, customizable, easy-to-use transport apparatus for moving or transporting windows, doors, face frames, and any combinations together thereof.

### BRIEF SUMMARY

It is an objective of the present invention to provide a transport apparatus configured in the form of a modular moveable cart that can be easily adjusted at a site. The modularity of the product helps in the easy shipment of the transport apparatus from one place to another. The modularity also helps in the customization of the cart to hold just the doors, windows, face frames, or a combination of doors and face frames, or a combination of doors and windows, or a combination of windows and the face frames, and so on.

It is an objective of the present invention to provide a transport apparatus configured in the form of a no-wheel modular storage rack or container for the transportation and storage of cabinet subassemblies such as door panels, windows, and face frames without damaging each other during transportation.

It is an objective of the present invention to provide a transport apparatus that can be easily rolled within the warehouse and onto a delivery truck or a trailer or a van (rolled on a surface in general) to ship from the manufacturing facility to the warehouse to job site or loaded directly onto the delivery truck or van using piggyback lifts etc (especially for loading non-wheeled version of the transport apparatus).

It is an objective of the present invention to provide a transport apparatus that embodies spacers (a combination of fiberglass rods and ridges in the context of the present disclosure) to keep door panels, windows, face frames, or any combination thereof spaced apart and safe from damages against rattling during transportation.

Embodiments of the present invention discloses a transportation apparatus. The transportation apparatus includes a framework including a lower frame member, and a side frame member oriented upright over the lower frame member. The side frame member may be oriented substantially perpendicular to the lower frame member or oriented at an angle to the lower frame member.

In an embodiment, the lower frame member includes a pair of transverse braces and a plurality of first spaced apart and parallel elongated members extending between the pair of transverse braces. One of the selected elongated members comprises a plurality of first slots extending across two ends of the selected elongated member. The first slots extending across two ends of the selected elongated member are similar to and coincide with the plurality of third slots of the flat bottom member when the flat bottom member is configured over the lower frame member.

In an embodiment, the side frame member includes a pair of upright posts. Each of the upright posts is mounted onto the transverse braces, a plurality of second spaced apart and parallel elongated members extending between the pair of upright posts. The at least one of the selected elongated members comprises a plurality of second slots extending across the two ends of the selected elongated members. The plurality of second slots extending across the two ends of the selected elongated members are similar to and coincide with the plurality of fourth slots and the plurality of fifth slots of at least one flat side member.

In an embodiment, the transportation apparatus includes a flat bottom member supported on the lower frame member, the flat bottom member comprising a plurality of third slots configured in proximity to its one end, and a plurality of first ridges spaced apart from each other and extending from the plurality of third slots to another end.

In an embodiment, the transportation apparatus includes at least one flat side member supported on the side frame member. The flat side member comprises a plurality of fourth slots and a plurality of fifth slots configured in proximity to one end of the at least one flat side member, and a plurality of second ridges spaced apart from each other and extending from the plurality of fourth slots and the plurality of fifth slots to another end of the at least one flat side member.

In an embodiment, the transportation apparatus includes a plurality of separators each having a first end and a second end, the plurality of separators are spaced apart from each other and diagonally oriented to connect the flat bottom member and the at least one flat side member. The plurality of separators comprises at least a fiberglass rod. The separators are spaced apart using a similar distance as between the plurality of first ridges of the flat bottom member and the plurality of second ridges, of the flat side member. The first end of the separators engages a combination of the plurality of third slots of the flat bottom member and the plurality of first slots of the selected elongated member, and the second end of the plurality of separators engages a combination of the plurality of fourth slots and fifth slots of the at least one flat side member and the plurality of second slots of the selected elongated members. The separators extend over the ridges 104a of the flat bottom member 104 and the ridges of at least one flat side member.

In an embodiment, the plurality of first ridges, and the plurality of second ridges are aligned on the same plane and comprise a plurality of retaining spaces for slidably receiving and safely securing cabinet subassemblies. The cabinet subassemblies retained within the plurality of retaining spaces are further separated by the plurality of separators preventing any damages to the cabinet subassemblies from rattling during the movement of the transportation apparatus. The cabinet subassemblies comprise of at least door panels, windows, and/or face frames.

In an embodiment, the transportation apparatus further includes at least one shelf removably configurable on the side frame member and comprises at least one shelf member configured thereon.

In an embodiment, the transportation apparatus further includes a handle attached to the upright posts of the side frame member and one or more S-clips hung over the selected elongated member of the side frame member.

In an embodiment, the transportation apparatus further comprises a set of wheels attached to the lower frame member that may help in moving the transportation apparatus along a surface.

In an embodiment, the transportation apparatus further a pair of sidewalls and a top wall for enclosing the cabinet subassemblies from three sides.

These and other features and advantages along with other embodiments of the present invention will become apparent from the detailed description below, in light of the accompanying drawings.

### BRIEF DESCRIPTION OF THE ACCOMPANYING DRAWINGS

The novel features which are believed to be characteristic of the present disclosure, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Some components such as slots located on shelves 103g,103h, framework 101, and other parts of the apparatus though described in the description and may not be visible in the drawings. Although not seen, person skilled in the art can Embodiments of this disclosure will now be described by way of example in association with the accompanying drawings in which:

FIG. 1 shows a front-perspective view of a transport apparatus, according to an embodiment of the present invention.

FIG. 2 shows a rear perspective view of the transport apparatus of FIG. 1.

FIG. 3 shows a bottom perspective view of the transport apparatus of FIG. 1.

FIG. 4 shows an enlarged view of a portion of FIG. 1.

FIG. 5 shows an enlarged view of a portion of FIG. 2.

FIG. 6 shows a side view of the transport apparatus of FIG. 1.

FIG. 7 shows a top view of a transport apparatus, according to another embodiment of the present invention.

FIG. 8 shows a front perspective view of the transport apparatus of FIG. 7.

FIG. 9 shows a front view of the transport apparatus of FIG. 7.

FIG. 10 shows a front perspective view of a transport apparatus, according to yet an embodiment of the present invention.

FIG. 11 shows multiple cabinet doors, panels and face frames mounted onto the transport apparatus of FIG. 8, according to an exemplary embodiment.

FIGS. 12 and 13 show a sectional view of the transport apparatus of FIG. 11 with cabinet doors or panels and face frames.

FIG. 14 shows a front perspective view of a no-wheel transport apparatus configured in the form of a container for ease of transporting, according to an exemplary embodiment of the present invention.

FIGS. 15 and 16 show a delivery truck or a van with multiple transport apparatuses loaded thereon to ship from one location to another.

### DETAILED DESCRIPTION

As used in the specification and claims, the singular forms “a”, “an” and “the” may also include plural references. For example, the term “an article” may consist of a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention. There may be additional components described in the foregoing application that are not depicted in one of the described drawings. In the event such a component is described, but not depicted in a drawing, the absence of such a drawing should not be considered as an omission of such design from the specification.

Before describing the present invention in detail, it should be observed that the present invention utilizes a combination of mechanical components, which constitutes a transport apparatus configured for the transportation and storage of cabinet subassemblies such as door panels, windows, and/or face frames without damaging each other. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open-ended in that an item or items following any one of these words is not meant to be an exhaustive listing of such item or items or meant to be limited to only the listed item or items. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

A transport apparatus configured for the transportation and storage of cabinet subassemblies such as door panels, windows, and/or face frames without damaging each other will now be described with reference to the accompanying drawings which should be regarded as merely illustrative without restricting the scope and ambit of the disclosure.

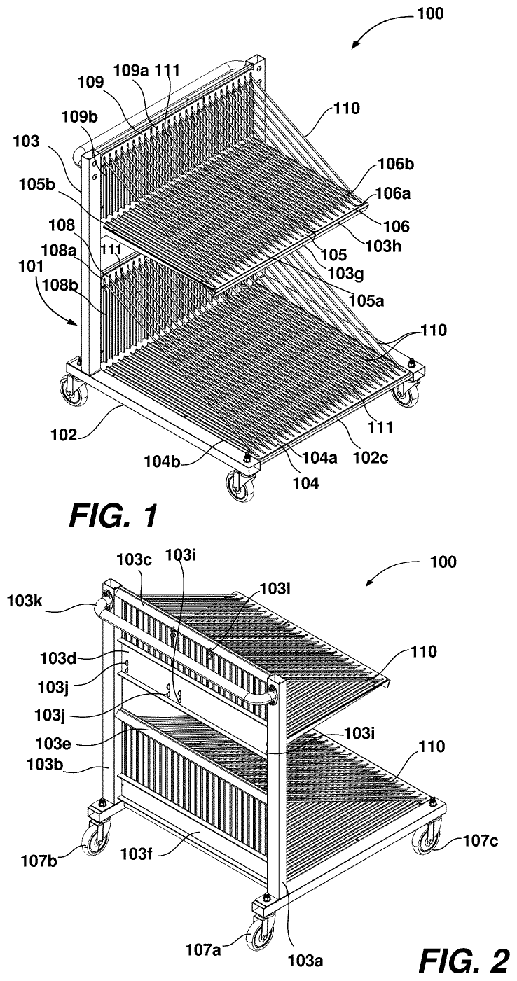

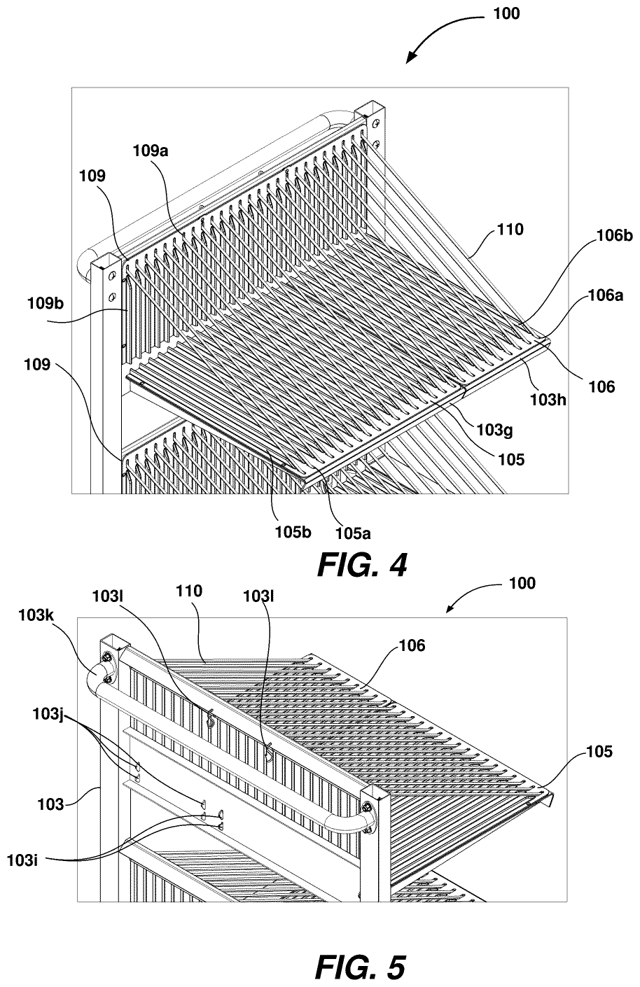

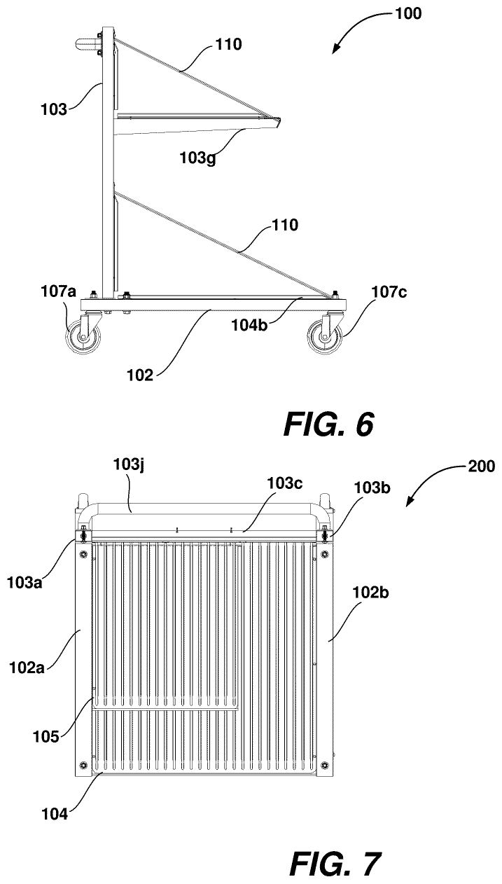

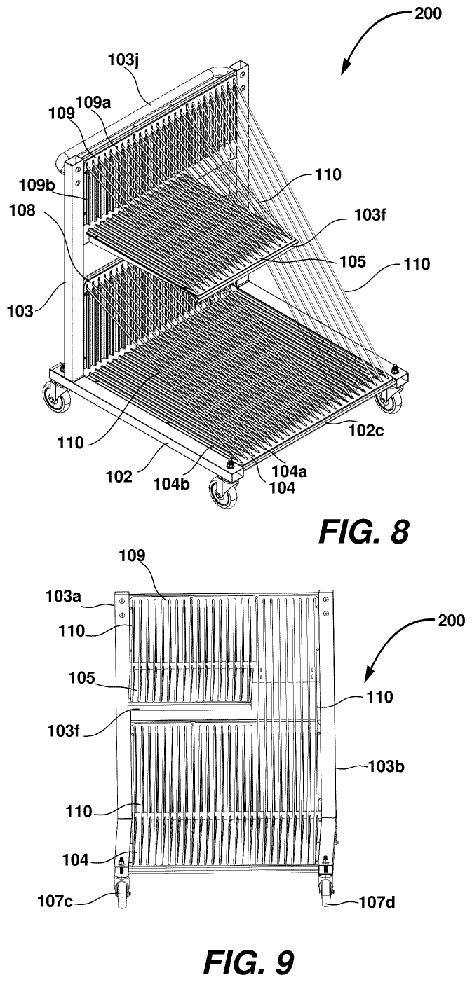

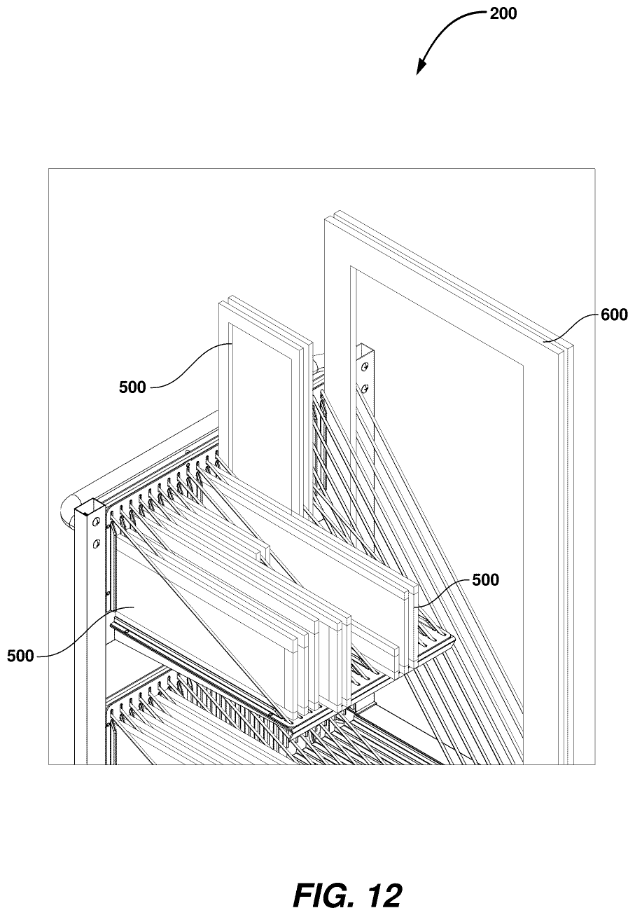

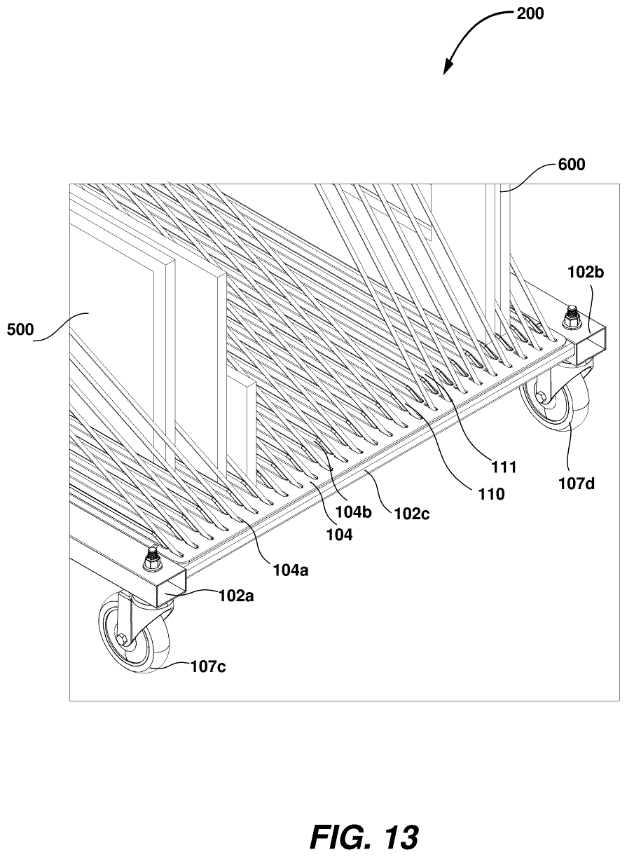

Referring to FIGS. 1-16, particularly to FIGS. 1-6, a transport apparatus for the transportation and storage of cabinet subassemblies such as door panels, windows, and/or face frames without damaging each other is shown according to an embodiment of the present invention. The apparatus 100 includes a framework 101. The framework 101 includes a lower frame member 102, and a side frame member 103 oriented upright over the lower frame member 102.

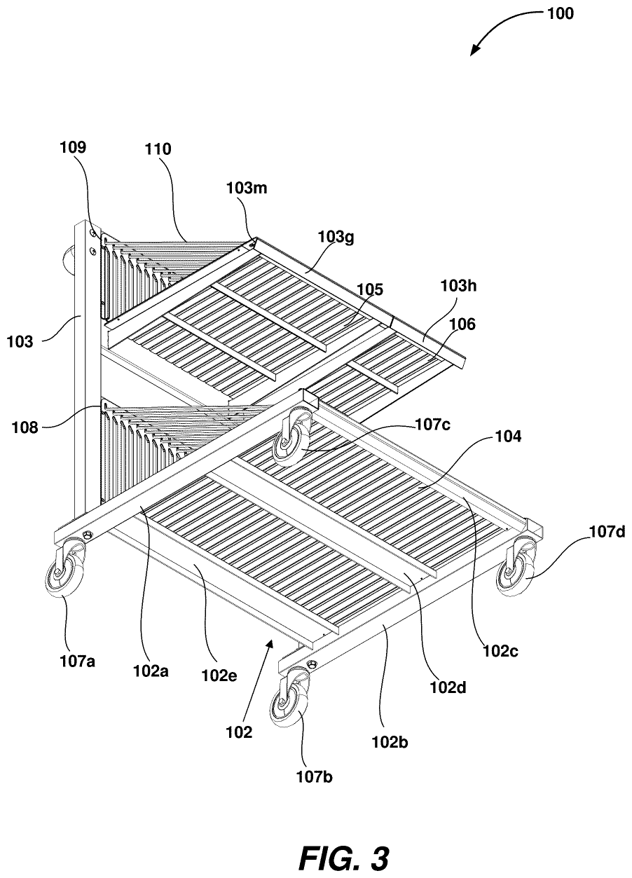

As best seen in FIG. 3, the lower frame member 102 includes a pair of transverse braces 102a and 102b. The braces 102a, and 102b may have but are not limited to square or rectangular cross sections. A plurality of spaced apart and parallel elongated members 102c-102e extends between the pair of transverse braces 102a and 102b. The elongated members 102c-102e may have predefined lengths and widths and have similar or dissimilar dimensions or configurations. In an embodiment, the elongated members 102c-102e may be welded to the braces 102a, and 102b. In another embodiment, the elongated members 102c-102e may be connected to the braces 102a, and 102b using nut and bolt or other known fastening mechanisms. One of the elongated members or a right-most elongated member 102c includes a plurality of first slots (not seen) extending across the two ends of the elongated member 102c. The lower frame member 102 is preferably made using metal, however, it should be understood that the lower frame member 102 may be made using other materials such as wood, and so on.

Similarly, the side frame member 103 includes a pair of upright posts 103a, and 103b. Each of the upright posts 103a, and 103b is mounted onto the transverse braces 102a and 102b respectively as best seen in FIG. 2. The upright posts 103a, and 103b may have but are not limited to square or rectangular cross sections. In an embodiment, the upright posts 103a, and 103b are shaped identical to the transverse braces 102a and 102b. A plurality of spaced apart and parallel elongated members 103c-103f extends between the pair of upright posts 103a, and 103b. The elongated members 103c-103f may have predefined lengths and widths and may have similar or dissimilar dimensions or configurations. In an embodiment, the elongated members 103c-103f may be welded to the upright posts 103a, and 103b or connected using other known mechanical fasteners such as nuts and bolts. One or more of the elongated members includes a plurality of second slots (not seen) extending across the two ends of the selected elongated members. In an example embodiment, an intermediate elongated member 103e and the top most elongated member 103c comprise the plurality of second slots (not seen). The side frame member 103 is preferably made using metal, however, it should be understood that the side frame member 103 may be made using other materials such as wood, and so on.

In an embodiment, the side frame member 103 may be oriented substantially perpendicular to the lower frame member 102. In another embodiment, the side frame member 103 may be oriented at a predefined angle (90 degrees) to the lower frame member 102.

A flat bottom member 104 is supported on the lower frame member 102. The flat bottom member 104 is supported on the lower frame member 102 using suitable fasteners. The flat bottom member 104 is preferably vacuum formed using plastic or other suitable material such as high-density polyethylene (HDPE) according to an embodiment. The material is chosen such that the flat bottom member 104 remains chemical resistant from the painted doors, windows, and face frames. In some other embodiment, the flat bottom member 104 may be made using rubber material, made in the form of a carpet, or be substituted with grooved-cut foam, and so on.

The flat bottom member 104 includes a plurality of third slots 104a in proximity to its first end. The flat bottom member 104 includes a plurality of first ridges 104b spaced apart from each other and extending from the plurality of third slots 104a to another end of the flat bottom member 104 as seen in FIG. 1. There are retaining spaces 111 formed between the ridges 104b. In assembly, when the flat bottom member 104 is configured onto the lower frame member 102, the plurality of third slots 104a of the flat bottom member 104 coincides with the plurality of first slots located across two ends of the selected elongated member 102c of the lower frame member 102. In the example shown, the right-most elongated member 102c embodies the slots that coincide with the slots 104a of the flat bottom member 104.

Further, the transport apparatus 100 includes at least one flat side member, namely flat side members 108 and 109 (FIG. 1 shows two flat side members) supported on the side frame member 103. The flat side members 108 and 109 are configured on the side frame member 103 using suitable fasteners. The flat side members 108 and 109 are preferably vacuum formed using plastic or other suitable material such as high-density polyethylene (HDPE) according to an embodiment. The material is chosen such that the flat side members 108 and 109 remain chemical resistant from the painted doors, windows, and face frames. In some other embodiment, the flat side members 108 and 109 may be made using rubber material, made in the form of a carpet, or be substituted with grooved-cut foam, and so on.

In the embodiment shown in FIGS. 1-6, the transport apparatus 100 specifically includes two flat side members 108,109, each comprising a plurality of fourth slots 108a, and fifth slots 109a configured in proximity to one end of respective flat side members 108,109. The two flat side members 108,109 include a plurality of second ridges 108b, and 109b, spaced apart from each other and extending from the plurality of fourth slots 108a and fifth slots 109a to another end of the side members 108,109. The plurality of second slots extending across the two ends of the selected elongated members 103c, and 103e respectively coincide with the fourth slots 108a, and fifth slots 109a configured in proximity to one end of the flat side member 108,109. There are retaining spaces 111 formed between the ridges 108b, and the 109b. The ridges 104b of the flat bottom member 104, and ridges 108b, and 109b of the flat side member 108,109 are aligned on the same plane. Although the embodiment presented herein in FIGS. 1-6 shows the presence of two flat side members 108,109, it is possible that there may be just one flat side member just like the member 104 or it may be possible to include more number of such side members 108,109.

Further, the transport apparatus 100 includes a plurality of separators 110. Each of the separators 110 includes a first end and a second end. The separators 110 are spaced apart and diagonally oriented to connect the flat bottom member 104 and the flat side member 108,109. The separators 110 are spaced apart with a similar distance as the distance between the ridges 104b of the flat bottom member 104 and the ridges 108b, and 109b of the flat side member 108, 109. The separators 110 extend over the ridges 104b of the flat bottom member 104 and the ridges 108b, 109b of the flat side member 108,109. The separators 110 according to the preferred embodiment include fiberglass rods. In some other embodiment, the separators 110 may include metal rods, plastic rods, strings, ropes, and so on.

The fiberglass rods 110 can flex and pass through a combination of the third slots 104a of the flat bottom member 104 and the first slots of the selected elongated member 102c of the frame member 102 and once inserted are relaxed to retain the end within the slots combination. The fiberglass rods 110 can flex and pass through a combination of the fourth and fifth slots 108a, 109a of the flat side member 108,109 and the second slots of the selected elongated members 103c, 103e of the frame member 103 and once inserted are relaxed to retain the corresponding end within the slots combination.

In an embodiment, the transport apparatus 100 may further include one or more shelves 103g, 103h removably and selectively configurable on the side frame member 103. In the example, one of the shelf 103g covers ⅔^{rd} of the width of the apparatus 100 whereas the shelf 103h covers ⅓^{rd} of the width of the apparatus 100. However, it may be possible to have different widths for these shelves 103g, 103h. The shelves 103g, and 103h may be attached to the selected elongated member, such as the elongated member 103d using many known techniques. Although it is seen that the shelves 103g, 103h are attached to the elongated member 103d, it should be understood that the shelves 103g, 103h may be configured on the other elongated members, for example 103f depending upon the dimensional need of the apparatus 100 or the sizes of door panels, windows etc. one needs to carry and move using the apparatus 100. One of the known techniques for removably attaching the shelves to the elongated member 103d is seen in FIGS. 2 and 5. As seen, the shelves 103g and 103h may preferably incorporate locking tabs 103j, and 103i at their one end that may be selectively inserted and secured within a set of holes located on the selected elongated member 103d to lock the shelves 103g and 103h in place. The example embodiment shows the presence of two shelves 103g, and 103h together extending to cover the entire width of the apparatus 100, however, it should be understood that instead of two shelves there can be just one single shelf extending to the full width of the apparatus 100, or there could be three or more number of shelves instead of two shelves. Further, the shelves 103g, 103h comprise of slots 103m that align with the slots 105a, 106a of the flat shelf members 105,106 105,106 respectively arranged on top of the shelves 103g, 103h.

Each of the shelves 103g, 103h further includes flat shelf members 105,106 similar to the flat bottom member 104 mounted over the shelves 103g, 103h and fastened thereto using suitable fasteners. Each of the flat shelf members 105,106 are identical in configuration to the flat bottom member 104, thus further elaboration on the flat shelf members 105,106 is intentionally omitted herein to keep the description concise.

Referring to FIGS. 2 and 5, the transport apparatus 100 may further include a handle 103k attached to the upright posts 103a and 103b of the side frame member 103. The handle 103k helps in moving the transport apparatus 100 on a surface using a set of wheels 107a-107d configured on the transport apparatus 100. The handle 103k may be either permanently welded or may be removably fixed on the upright posts 103a, and 103b using suitable fasteners such as nut and bolt. The transport apparatus 100 may include one or more S-clips 1031 hung over the elongated member 103c of the side frame member 103. The S-clips 1031 passes through holes provided on the elongated member 103c. The S-clips 1031 may be useful for putting on some informational cards or job cards pertaining to the cabinet doors, windows and face frames, etc mounted on the transport apparatus 100.

Although the preferred embodiment (FIGS. 1-6), shows the transport apparatus 100 with a flat bottom member 104 serving as a base shelf, two flat side members 108,109 and two shelves 103g, 103h with corresponding flat shelf member 105,106, it should be understood that many other configurations are possible. The embodiment for the transport apparatus 100 represented in FIGS. 1-6 essentially is useful for holding different cabinet door panels 500 of varying dimensions with a first set retained on the flat bottom member 104 and a second set retained on the upper two shelves 103g, 103h. The sizes of the cabinet doors held on the flat bottom member 104 and the upper two shelves 103g, 103h may differ.

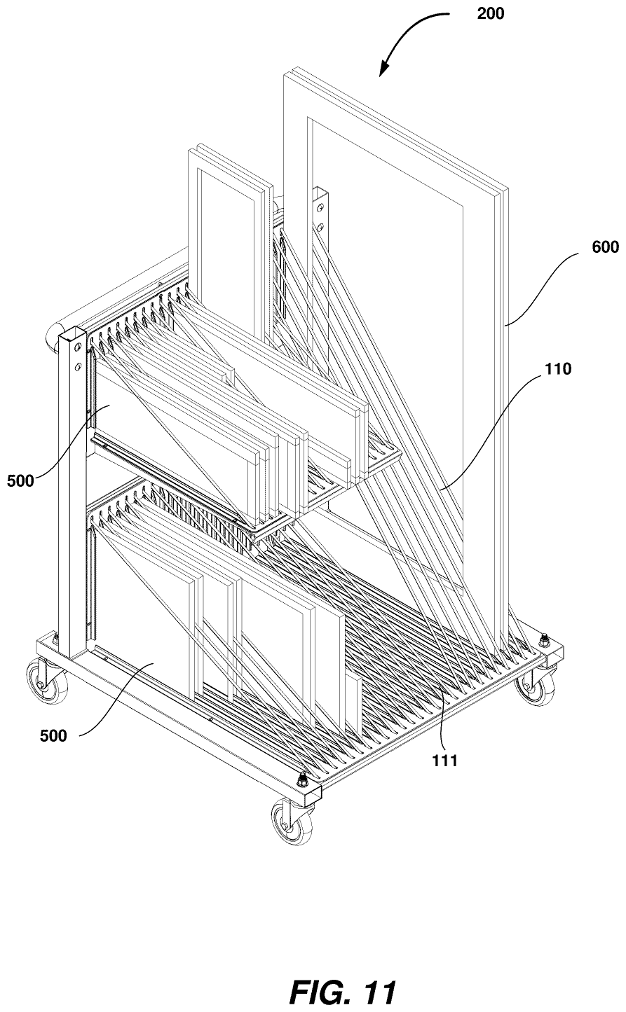

Another exemplary embodiment of the transport apparatus 200 is seen in FIGS. 7-9. The embodiment represented in FIGS. 7-9 is essentially the same as the transport apparatus 100 shown in FIGS. 1-6 except for shelves 103g, 103h. The embodiment of the transport apparatus 200 shown in FIGS. 7-9 includes just one shelf 103g (with the shelf 103h removed) covering ⅔^{rd} of the width of the transport apparatus 200. This configuration of the transport apparatus 200 is particularly useful for retaining differently sized doors, windows, face frames etc. As seen in FIGS. 11-13, the transport apparatus 200 is shown holding differently sized cabinet doors 500 and face frames 600. The removal of the shelf 103h in this embodiment helps in retaining a larger sizes of face frames 600 which may not be possible with the embodiment shown in FIGS. 1-6. As seen, ⅓^{rd} of the transport apparatus 200 is able to hold the face frames 600 and ⅔^{rd} of the transport apparatus 200 is able to hold the cabinet doors 500 of varying sizes within the retaining spaces 111 of the two flat side members 108,109, the flat bottom member 104 and the flat shelf member 105. As seen in FIGS. 11-13, the cabinet doors 500, and face frames 600 securely retained between the ridges 104b, 108b, 109b, 105b, 106b and separated from each other by the separators 110.

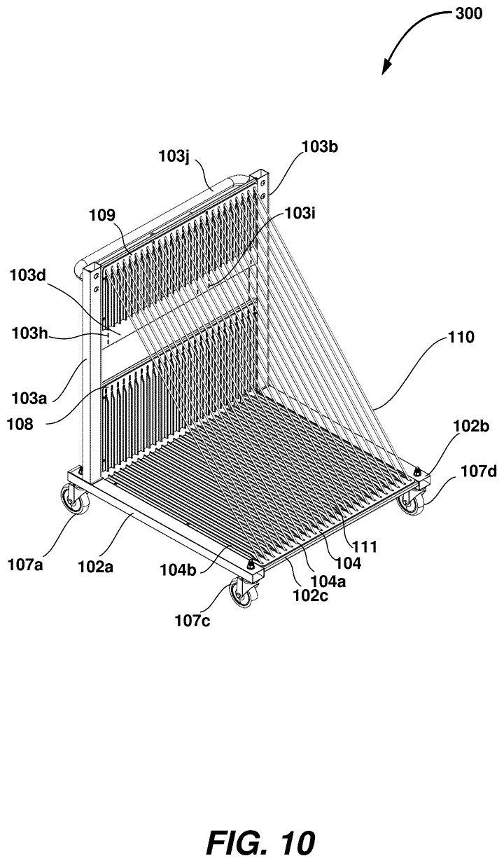

Referring to FIG. 10 that shows transport apparatus 300, according to yet an embodiment of the present invention. The embodiment represented in FIG. 10 is essentially the same as the transport apparatus 100 shown in FIGS. 1-6 except for shelves 103g, 103h. The embodiment of the transport apparatus 300 shown in FIG. 10 doesn't include any shelves (with the shelf 103g, 103h removed). This configuration of the transport apparatus 300 is particularly useful for retaining larger sizes of face frames, doors etc.

In the light of embodiments for the transport apparatus 100, 200, 300, it can be understood that it is possible to embody the transport apparatus in many different forms with or without shelves or with a lesser or a greater number of shelves.

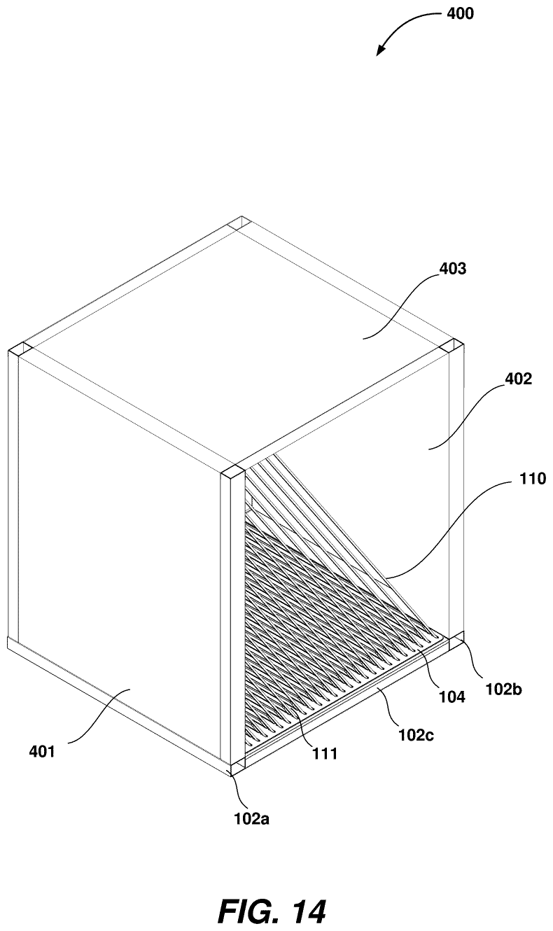

Referring to FIG. 14 shows yet another possible embodiment for the transport apparatuses described above. In this specific embodiment, the transport apparatus 400 is configured in the form of a container or a box. As seen, this embodiment may be similar to the embodiment in FIGS. 1-6, with side walls 401,402 and a top wall 403 that would enclose the cabinet subassemblies 500 such as door panels, windows inside. One side of the transport apparatus 400 may be left open for ease of insertion and removal of the cabinet subassemblies 500. In this embodiment, depending upon the size of the constructed transport apparatus 400 there may be shelves (103g, 103h) or there may not be shelves except the flat bottom member 104 and the flat side member 108,109. The flat side member 108,109 may be present as a single one-piece flat side member or as two pieces as shown in FIGS. 1-6. In the embodiment shown in FIG. 14, wheels and handle may not be required. This configuration of the transport apparatus 400 may be useful and can be loaded or unloaded from vehicle or trucks using piggyback lifts or hydraulic lifting vehicles or systems usually available in worksites or warehouses etc.

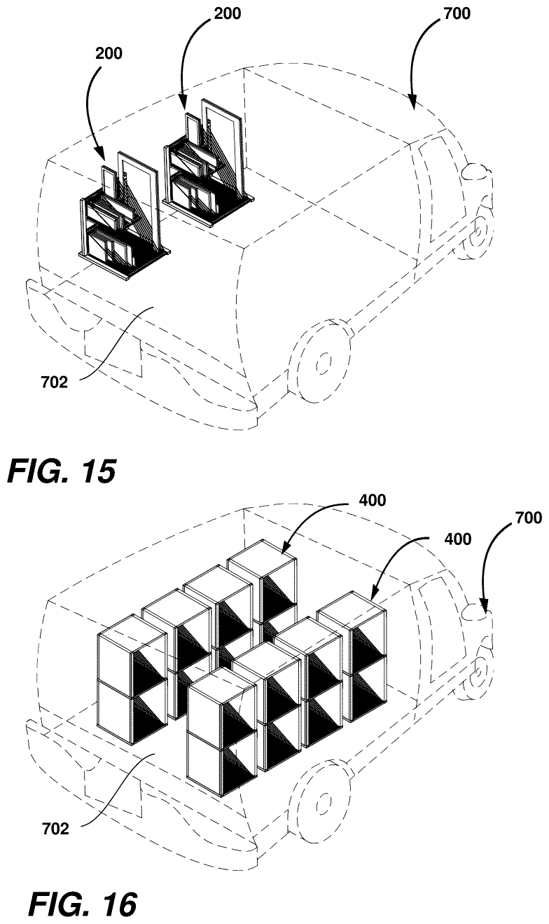

Further, FIGS. 15-16 shows a delivery truck or a van with multiple transport apparatuses loaded thereon to ship from one location to another. FIG. 15 specifically shows the transport apparatuses 200 holding cabinet doors, face frames. The apparatuses 200 as seen are without the wheels and configured for mounting onto the walls of the back body of the delivery truck/van 700. Although only two the transport apparatuses 200 are shown loaded on the back of the truck/van 700 it should be understood that any other number of such apparatuses can be transported. Likewise, FIG. 16 shows the transport apparatuses 400 that may be used for holding cabinet doors. The apparatuses 400 as seen are without the wheels and closed from all sides except from one side and can be used like any normal delivery containers and easily mounted and unmounted from the truck bed or van's bed. Such apparatuses 400 as configured can be easily stacked on top of one another to effectively utilize the space in the back of the truck body.

Although particular embodiments of the invention have been described in detail for purposes of illustration, various modifications, and enhancements may be made without departing from the spirit and scope of the invention.

What is claimed is:

1. A transportation apparatus (100,200,300,400), comprising:
a framework (101) comprising
a lower frame member (102), and
a side frame member (103) oriented upright over the lower frame member (102);
a flat bottom member (104) supported on the lower frame member (102), the flat bottom member (104) comprising a plurality of third slots (104a) configured in proximity to its one end, and a plurality of first ridges (104b) spaced apart from each other and extending from the plurality of third slots (104a) to another end;
at least one flat side member (108,109) supported on the side frame member (103), the at least one flat side member (108,109) comprising a plurality of fourth slots and a plurality of fifth slots (108a, 109a) configured in proximity to one end of the at least one flat side member (108,109), and a plurality of second ridges (108b,109b) spaced apart from each other and extending from the plurality of fourth slots and the plurality of fifth slots (108a, 109a) to another end of the at least one flat side member (108,109);
a plurality of separators (110) each having a first end and a second end, the plurality of separators (110) are spaced apart from each other and diagonally oriented to connect the flat bottom member (104) and the at least one flat side member (108,109);
wherein, the plurality of first ridges (104b), and the plurality of second ridges (108b,109b) are aligned on the same plane and comprises a plurality of retaining spaces (111) for slidably receiving and safely securing cabinet subassemblies (500,600); and
wherein the cabinet subassemblies (500,600) retained within the plurality of retaining spaces (111) are further separated by the plurality of separators (110) preventing any damages to the cabinet subassemblies (500,600) from rattling during the movement of the transportation apparatus (100).

2. The transportation apparatus (100,200,300,400) of claim 1, wherein the side frame member (103) is oriented substantially perpendicular to the lower frame member (102).

3. The transportation apparatus (100,200,300,400) of claim 1, wherein the side frame member (103) is oriented at a predefined angle to the lower frame member (102).

4. The transportation apparatus (100,200,300,400) of claim 1, wherein the lower frame member (102) comprising:
a pair of transverse braces (102a,102b); and
a plurality of first spaced apart and parallel elongated members (102c-102e) extending between the pair of transverse braces (102a, 102b).

5. The transportation apparatus (100,200,300,400) of claim 4, wherein one of the selected elongated members (102c) comprises a plurality of first slots extending across two ends of the selected elongated member (102c).

6. The transportation apparatus (100,200,300,400) of claim 5, wherein the plurality of first slots extending across two ends of the selected elongated member (102c) are similar to and coincides with the plurality of third slots (104a) of the flat bottom member (104) when the flat bottom member (104) is configured over the lower frame member (102).

7. The transportation apparatus (100,200,300,400) of claim 1, wherein the side frame member 103 comprising:
a pair of upright posts (103a,103b), wherein each of the upright posts (103a, 103b) is mounted onto the transverse braces (102a, 102b);
a plurality of second spaced apart and parallel elongated members (103c-103f) extending between the pair of upright posts (103a, 103b).

8. The transportation apparatus (100,200,300,400) of claim 7, wherein at least one of the selected elongated members (103c,103e) comprises a plurality of second slots extending across the two ends of the selected elongated members (103c, 103e).

9. The transportation apparatus (100,200,300,400) of claim 7, wherein the plurality of second slots extending across the two ends of the selected elongated members (103c,103e) are similar to and coincide with the plurality of fourth slots and the plurality of fifth slots (108a, 109a) of the at least one flat side member (108,109).

10. The transportation apparatus (100,200,300,400) of claim 1, wherein the plurality of separators (110) comprises at least a fiberglass rod.

11. The transportation apparatus (100,200,300,400) of claim 1, wherein the plurality of separators (110) are spaced apart using a similar distance as between the plurality of first ridges (104b) of the flat bottom member (104) and the plurality of second ridges (108b, 109b) of the flat side member (108,109).

12. The transportation apparatus (100,200,300,400) of claim 1, wherein
the first end of the plurality of separators (110) engages a combination of the plurality of third slots (104a) of the flat bottom member (104) and the plurality of first slots of the selected elongated member (102c), and
the second end of the plurality of separators (110) engages a combination of the plurality of fourth slots and fifth slots (108a, 109a) of the at least one flat side member (108,109) and the plurality of second slots of the selected elongated members (103c, 103e).

13. The transportation apparatus (100,200,300,400) of claim 1, wherein the cabinet subassemblies (500,600) comprises at least door panels, windows, and/or face frames.

14. The transportation apparatus (100,200,300,400) of claim 1, wherein the plurality of separators (110) extends over the plurality of first ridges (104a) of the flat bottom member (104) and the plurality of second ridges (108b,109b) of at least one flat side member (108,109).

15. The transportation apparatus (100,200,300,400) of claim 1 further comprising at least one shelf (103g,103h) removably configurable on the side frame member (103) and comprises at least one shelf member (105,106) configured thereon.

16. The transportation apparatus (100,200,300,400) of claim 1 further comprising
a handle (103k) attached to the upright posts (103a,103b) of the side frame member (103); and
one or more S-clips (1031) hung over the selected elongated member (103c) of the side frame member (103).

17. The transportation apparatus (100,200,300,400) of claim 1 further comprises a set of wheels (17a-107d) attached to the lower frame member (102) that may help in moving the transportation apparatus (100,200,300) along a surface.

18. The transportation apparatus (100,200,300,400) of claim 1 further comprises a pair of sidewalls (401,402) and a top wall (403) for enclosing the cabinet subassemblies (500,600) from three sides.

19. A transportation apparatus (100,200,300,400), comprising:
a framework (101) comprising
a lower frame member (102), wherein the lower frame member (102) comprising: a pair of transverse braces (102a, 102b); and a plurality of first spaced apart and parallel elongated members (102c-102e) extending between the pair of transverse braces (102a, 102b);
a side frame member (103) oriented upright over the lower frame member (102), wherein the side frame member 103 comprising: a pair of upright posts (103a, 103b), wherein each of the upright posts (103a, 103b) is mounted onto the transverse braces (102a, 102b);
a plurality of second spaced apart and parallel elongated members (103c-103f) extending between the pair of upright posts (103a, 103b);
a flat bottom member (104) supported on the lower frame member (102), the flat bottom member (104) comprising a plurality of third slots (104a) configured in proximity to its one end, and a plurality of first ridges (104b) spaced apart from each other and extending from the plurality of third slots (104a) to another end;
at least one flat side member (108,109) supported on the side frame member (103), the at least one flat side member (108,109) comprising a plurality of fourth slots and a plurality of fifth slots (108a, 109a) configured in proximity to one end of the at least one flat side member (108,109), and a plurality of second ridges (108b, 109b) spaced apart from each other and extending from the plurality of fourth slots and the plurality of fifth slots (108a, 109a) to another end of the at least one flat side member (108,109);
a plurality of separators (110) each having a first end and a second end, the plurality of separators (110) are spaced apart from each other and diagonally oriented to connect the flat bottom member (104) and the at least one flat side member (108,109);
wherein, the plurality of first ridges (104b), and the plurality of second ridges (108b,109b) are aligned on the same plane and comprises a plurality of retaining spaces (111) for slidably receiving and safely securing cabinet subassemblies (500,600); and
wherein the cabinet subassemblies (500,600) retained within the plurality of retaining spaces (111) are further separated by the plurality of separators (110) preventing any damages to the cabinet subassemblies (500,600) from rattling during the movement of the transportation apparatus (100).

20. A transportation apparatus (100,200,300,400), comprising:
a framework (101) comprising
a lower frame member (102), and
a side frame member (103) oriented upright over the lower frame member (102);
a flat bottom member (104) supported on the lower frame member (102), the flat bottom member (104) comprising a plurality of third slots (104a) configured in proximity to its one end, and a plurality of first ridges (104b) spaced apart from each other and extending from the plurality of third slots (104a) to another end;
at least one flat side member (108,109) supported on the side frame member (103), the at least one flat side member (108,109) comprising a plurality of fourth slots and a plurality of fifth slots (108a, 109a) configured in proximity to one end of the at least one flat side member (108,109), and a plurality of second ridges (108b, 109b) spaced apart from each other and extending from the plurality of fourth slots and the plurality of fifth slots (108a, 109a) to another end of the at least one flat side member (108,109);
a plurality of separators (110) each having a first end and a second end, the plurality of separators (110) are spaced apart from each other and diagonally oriented to connect the flat bottom member (104) and the at least one flat side member (108,109);
at least one shelf (103g,103h) removably configurable on the side frame member (103) and comprises at least one shelf member (105,106) configured thereon;
a set of wheels (17a-107d) attached to the lower frame member (102) that may help in moving the transportation apparatus (100,200,300) along a surface;
wherein, the plurality of first ridges (104b), and the plurality of second ridges (108b,109b) are aligned on the same plane and comprises a plurality of retaining spaces (111) for slidably receiving and safely securing cabinet subassemblies (500,600); and
wherein the cabinet subassemblies (500,600) retained within the plurality of retaining spaces (111) are further separated by the plurality of separators (110) preventing any damages to the cabinet subassemblies (500,600) from rattling during the movement of the transportation apparatus (100).
